(19) United States
(12) Patent Application Publication
(10) Pub. No.: US 2002/0059836 A1
(43) Pub. Date: May 23, 2002

(54) Device for measuring a volume of flowable material, screw conveyor and flap assembly

(75) Inventor: David Dodsworth, Ontario (CA)

Correspondence Address: MICHAEL BEST & FRIEDRICH, LLP, 100 E WISCONSIN AVENUE, MILWAUKEE, WI, 53202, US

(73) Assignee: United States Filter Corporation, Palm Desert, CA

(21) Appl. No.: 09/999,278

(22) Filed: Nov. 15, 2001

Related U.S. Application Data
(60) Provisional application No. 60/249,579, filed on Nov. 17, 2000.

(51) Int. Cl. G01F 1/28

(52) U.S. Cl. 73/861.74

(57) ABSTRACT

A device for measuring a volume of flowable material and may be used for transporting dewatered biosolids over relatively short distances through a pipe. The device includes a screw conveyor including a conveyor housing, and a conveyor screw rotatably supported in the conveyor housing and operable to move flowable material through a housing outlet, and an electromagnetic flow meter operable to measure the volume of flowable material flowing from the housing outlet. The conveyor housing may include a generally cylindrical first portion and a tapered, generally frusto-conical second portion adjacent the housing outlet. The device may include a flap assembly supported adjacent the outlet of the flow meter. The device may include a pipe arrangement on the discharge of the flow meter.

### FIELD OF THE INVENTION

The present invention relates to the measurement of a volume of flowable material and, more particularly, to a device for measuring a volume of flowable material, such as dewatered municipal sludge.

### BACKGROUND OF THE INVENTION

Various state and federal regulations covering processing and disposal of sludge require that the processing apparatus accurately measure and record the amount of material handled. A typical sludge material handling system includes a sludge material feed system, such as a belt press, centrifuge or other devices for drying the sludge and/or delivering the sludge to material handling equipment.

The sludge material handling system also typically includes a sludge material disposal system which disposes of sludge delivered by the material handling equipment. Typically, the sludge material disposal system will include an incinerator which incinerates the sludge. However, the sludge material disposal system may include other means of disposing of the sludge material in accordance with Environmental Protection Agency (EPA) regulations.

In any case, EPA regulations frequently require accurate measurement and recording of the amount of sludge which is being disposed or fed to an incinerator. In most instances, a sludge material handling system requires at least three or four individuals to monitor and control the sludge and the sludge material disposal system.

Municipalities and other entities responsible for the disposal of dewatered biosolids often require a low cost method of accurately measuring the mass or volume of material and transporting it relatively short distances to trucks or bins for haulage to disposal.

One device for measuring the feed rate is a weigh belt conveyor. This device includes an open belt conveyor on weigh cells, and the waste is moved on the open belt conveyor and weighed before movement to the incinerator.

Another device for determining the feed rate to an incinerator is disclosed in U.S. Pat. No. 5,336,055. This device includes a positive displacement piston/cylinder pump and a sensor for sensing a parameter bearing a known relationship to an actual volume of waste material delivered during a pumping cycle. Generally, the flow volume is measured based on a signal which indicates when material begins to flow from the piston cylinder at a time following the beginning of piston movement during the pumping stroke. Because the pump cylinder may not be completely full, the material must be initially compressed until the pressure within the cylinder substantially equals the pressure at the pump outlet. This allows determination of the cylinder filling efficiency and, at that point, material flows from the cylinder, and the calculation of the material volume pumped is based on movement of the piston after the compression of the material.

Yet another device to determine the feed rate includes a positive displacement piston/cylinder pump (a “cake” pump) and a flow meter, such as an electromagnetic flow meter, positioned at the outlet of the pump and measuring the flow volume.

### SUMMARY OF THE INVENTION

One problem with the above-described sludge material handling systems is that several personnel are required to operate each system. Employing a number of individuals to monitor and control the sludge material handling system adds significant cost to the disposal of sludge. Additionally, such systems leave room for human error and make it difficult to keep accurate records of the amount of sludge handled by the system. Keeping accurate records is typically necessary to satisfy EPA requirements.

One problem with the above-described weigh belt conveyor is that the belt conveyor is open. Waste material can easily fall off the belt conveyor, creating a housekeeping problem, and the open belt conveyors do not contain the odor of the waste.

Another problem with the above-described weigh belt is that it requires considerable space and a minimum transportation distance to ensure effective and accurate load cell readings.

Another problem with the above-described weigh belt is that material being weighed must be uniformly loaded on the belt which is extremely difficult for thixotropic materials, requires periodic calibration of the belt, is impacted by materials sticking to the belt or ineffective belt scraping, and requires belt tracking adjustment and a transition assembly to downstream transportation equipment.

One problem with the devices including a positive displacement piston/cylinder pump, such as the device disclosed in U.S. Pat. No. 5,336,055 and the above-described device used with the electromagnetic flow meter, is that such a pump is very expensive and complex to operate and maintain.

Another problem with the device disclosed in U.S. Pat. No. 5,336,055 is that, because the volume is determined inferentially, based on the motion of the pump piston, rather than directly, based on the flow volume, this indirect volume measurement may not be as accurate as a direct volume measurement.

Yet another problem with the device disclosed by U.S. Pat. No. 5,336,055 is that the indirect, inferential measurement algorithm assumes that the inlet and discharge valves of the pump are completely tight and do not leak flow in either direction. As the inlet and discharge valves and seats wear, material may pass through a closed valve, decreasing the accuracy of the measurement.

The present invention provides a device for measuring a volume of flowable material that substantially alleviates the problems associated with the above-described devices. More particularly, in some aspects, the present invention provides a device including a closed screw conveyor and an electromagnetic flow meter for measuring the volume of flowable material moving from the screw conveyor.

Also, in other aspects, the present invention provides a screw conveyor including a conveyor housing having a generally cylindrical first portion and a tapered, generally frusto-conical second portion adjacent the housing outlet, and a screw supported in the conveyor housing and operable to move flowable material from the housing inlet to the housing outlet. Preferably, the screw has a helical outer surface defining a cylindrical first screw portion, slidably engaging the inner surface of the cylindrical portion of the conveyor housing, and a tapered second screw portion, which may slidably engage the inner surface of the tapered portion of the conveyor housing. The screw may include a shaft and a helically-shaped screw portion supported by the shaft for rotation with the shaft, the screw portion being spaced from the shaft and providing the helical outer surface of the first screw portion.

In addition, in yet other aspects, the present invention provides a screw conveyor including a conveyor housing, a conveyor screw rotatably supported in the conveyor housing, the screw having an outer surface slidably engaging the inner surface of the conveyor housing and spaced apart ends, and a bearing rotatably supporting the first end of the screw.

Further, in other aspects, the present invention provides a flap assembly for use with a flow meter, the flow meter having an outlet and being operable to measure a flow of flowable material. The assembly includes a movable flap member supported adjacent the meter outlet and movable between an open position, in which the meter outlet is open to allow flow of flowable material, and a closed position, in which the meter outlet is closed to prevent flow of flowable material, and a biasing member to bias the flap member toward the closed position. Preferably, the biasing member is a spring member connected to the flap member, and the biasing force applied by the biasing member is preferably adjustable.

One independent advantage of the present invention is that, because the screw conveyor is enclosed, waste material is not lost from the conveyor housing, and the conveyor housing contains the odor of the waste material.

Another independent advantage of the present invention is that the components of the device, the screw conveyor and the electromagnetic flow meter, are relatively inexpensive, in comparison to the positive displacement piston/cylinder pump.

Yet another independent advantage of the present invention is that, because the electromagnetic flow meter directly measures the flow volume of the waste, the volume measurement is more accurate than an indirect, inferential measurement. Also, in some aspects, the tapered section of the screw conveyor and/or the use of the movable flap assembly ensure consistent pressure in the electromagnetic flow meter and more accurate volume measurement by the electromagnetic flow meter.

A further independent advantage of the present invention is that, because the electromagnetic flow meter directly measures the flow volume of waste, the direct volume measurement does not assume and is not dependent on whether the conveying device is completely sealed, such as in the device disclosed in U.S. Pat. No. 5,336,055, and the direct measurement is, therefore, more accurate.

Another independent advantage of the present invention is that the device provides a compact, low cost method of measuring and transporting dewatered biosolids through, in some constructions, a pipe which can be routed through combinations of pipe elbows and pipe runs to downstream process equipment or disposal.

Other independent features and independent advantages of the present invention will become apparent to those skilled in the art upon review of the following detailed description, claims and drawings.

### BRIEF DESCRIPTION OF THE DRAWINGS

FIG. 1 is a side view of a device for measuring a volume of flowable material and embodying the invention.

FIG. 2 is a side view of a screw shown in FIG. 1.

FIG. 3 is a side view of a portion of the device illustrated in FIG. 1 and illustrating the movable flap assembly.

FIG. 4 is a top view of the portion of the device illustrated in FIG. 3.

FIG. 5 is a front view of the portion of the device illustrated in FIG. 3.

FIG. 6 is a side view of a first alternative construction of a device for measuring a volume of flowable material and embodying the invention.

FIG. 7 is a side view of a second alternative construction of a device for measuring a volume of flowable material and embodying the invention.

FIG. 8 is a side view of a third alternative construction of a device for measuring a volume of flowable material and embodying the invention.

Before one embodiment of the invention is explained in detail, it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION OF THE PREFERRED EMBODIMENT

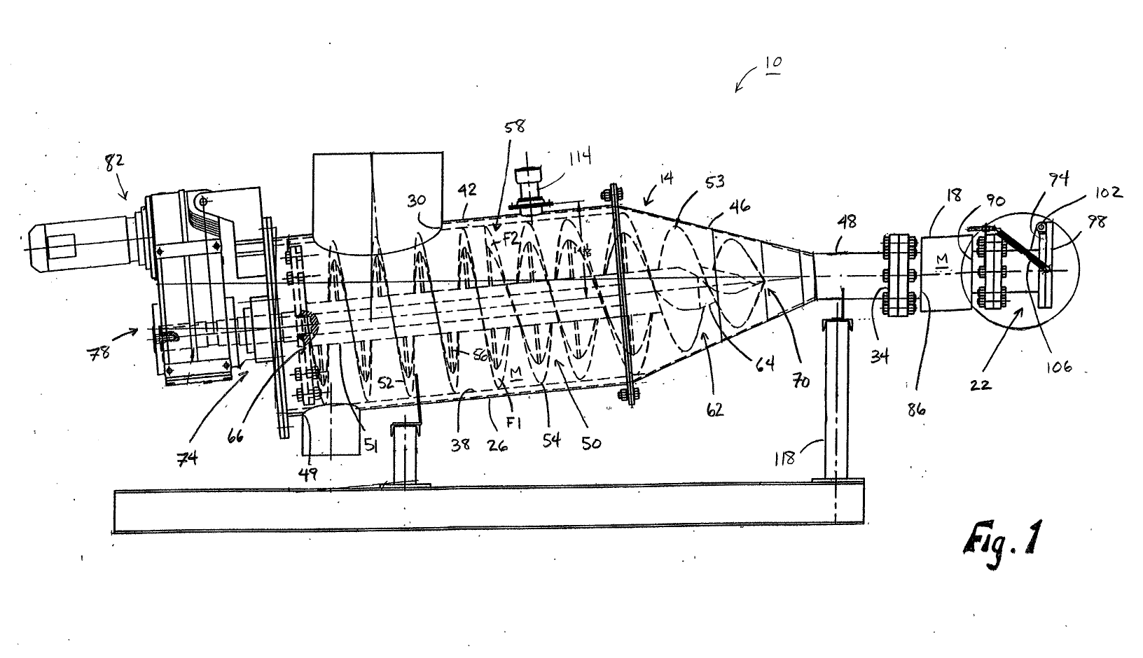

A device 10 for measuring a volume of flowable material M and embodying the invention is illustrated is FIG. 1. In the illustrated construction, the device 10 may be used to measure the volume of dewatered municipal sludge or bio-waste produced by a waste treatment facility before that waste is fed into an incinerator. However, in other constructions, the device 10 may be used to measure the volume of other flowable materials or in other systems in which precise volume measurement is necessary, such as, for example, in truck-loading facility billing or loading of other treatment process equipment, such as a dryer. In any of these constructions, the apparatus receiving the material M from the device 10, such as, for example, the incinerator, may be controlled and operated as a function of the actual volume of material M delivered by the device 10.

As shown in FIG. 1, the device 10 generally includes a screw conveyor 14, an electromagnetic flow meter 18, positioned downstream of the screw conveyor 14, and a movable flap assembly 22, positioned at the outlet of the flow meter 18. It should be understood that, in some aspects of the invention, these components may be different or may not be necessary to that aspect of the invention.

The screw conveyor 14 includes a trough or conveyor housing 26 which is substantially enclosed to contain the flowable material M as the flowable material M is moved through the device 10. The conveyor housing 26 has a housing inlet 30, for receiving flowable material M, and a housing outlet 34, through which flowable material M is discharged. The conveyor housing 26 has an inner surface 38 formed of a low friction material, such as UHMW.

In the illustrated construction and in some aspects of the invention, the conveyor housing 26 includes a generally cylindrical first portion 42, adjacent the inlet 30, and a tapered, generally frusto-conical second portion 46, downstream from the first portion 42 and adjacent the outlet 34. The conveyor housing 26 is tapered through the tapered second portion 46 to a generally cylindrical tunnel portion 48, forming the housing outlet 34. In the illustrated construction, the second portion 46 is tapered at an angle of about 20° from the longitudinal axis of the conveyor housing 26. In other constructions (not shown), the angle of taper may be different and may be an angle sufficient to transition from the diameter of the first portion 42 to the diameter of the tunnel portion 48 and/or to provide consistent pressure in the flow meter 18, as described below in more detail.

In the illustrated construction, the conveyor housing 26 is inclined to about 10° from the horizontal. A drain 49 is provided at the lower, inlet end of the conveyor housing 26 to drain free water from the conveyor housing 26. In some instances, such as to remove plugs of material M from the screw conveyor 14 or from the tunnel portion 48, water may be sprayed into the conveyor housing 26 at the outlet end and will be drained through the drain 49.

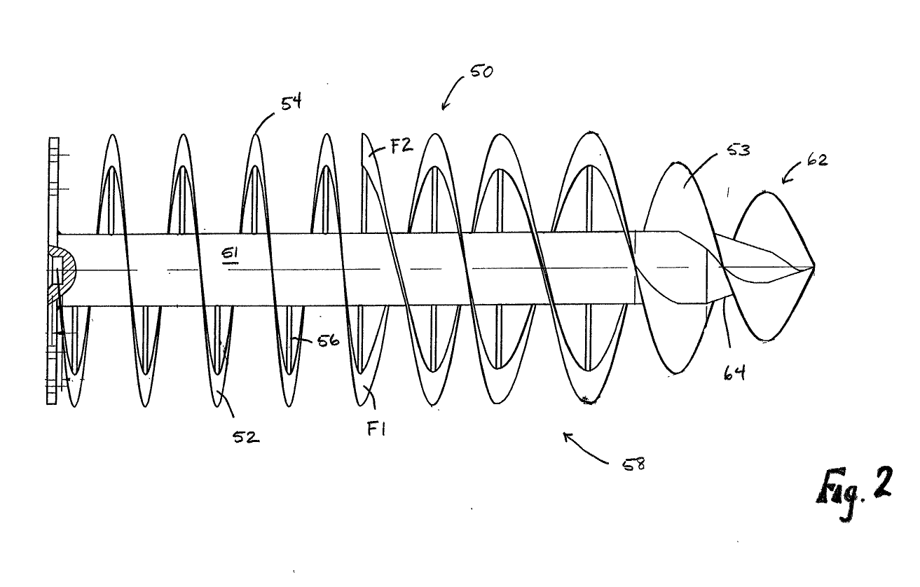

The screw conveyor 14 also includes (see FIGS. 1-2) an auger or screw 50 configured to move the flowable material M from the housing inlet 30 to the housing outlet 34. The screw 50 includes a shaft 51 supporting a helical ribbon screw portion 52 and a continuous screw portion 53 having a helical outer surface 54 which may slidingly engage the inner surface 38 of the conveyor housing 26. Radially-extending supports 56 extend between the shaft 51 and the ribbon screw portion 52.

In the illustrated construction and in some aspects of the invention, the helical outer surface 54 defines a cylindrical first portion 58, which is provided by the ribbon screw portion 52 and which slidingly engages the inner surface 38 of the cylindrical first portion 42, and a tapered second portion 62, which is provided by the continuous screw portion 53 and which may slidingly engage the inner surface 38 of the tapered second portion 46.

In the illustrated construction, the screw 50 preferably has a variable pitch. In the upstream section of the first portion 58, the ribbon screw portion 52 preferably has a 6 inch pitch. In the second portion 62, the continuous screw portion 53 preferably is a double start pitch having a 15-inch pitch. Through a transition section between the first portion 58 and the second portion 62, the ribbon screw portion 52 is a double start pitch (i.e., parallel flighting F1 with a second flighting F2 starting at the mid-point between the last two flights in the first portion 58). In the transition portion, the pitch of the ribbon screw portion 52 changes from a 6-inch pitch to a 15-inch pitch to transition between the upstream portion of the ribbon screw portion 52 and the continuous screw portion 53.

The screw 50 is preferably formed of a stainless steel. At the discharge end, a conical section of a torque tube 64, on which the flightings F1 and F2 are supported, is designed to optimize the volume reduction through the transition section while assisting to center the screw 50 when sludge material M is under pressure within transition section.

The screw 50 has a first inlet end 66 and a second outlet end 70, and the screw conveyor 14 also includes a support to support the screw 50 at the inlet end 66. In the illustrated construction, the support includes a bearing assembly 74 supporting the inlet end 66. The screw 50 is thus supported in a cantilevered arrangement with no intermediate bearings from the inlet end 66 to the outlet end 70. However, engagement of the outer surface 54 of the screw 50 with the inner surface 38 of the conveyor housing 26 may provide additional support to the screw 50 along a sufficient length of the screw.

The screw conveyor 14 also includes a drive assembly 78 including a drive motor 82 for rotatably driving the screw 50. In the illustrated construction, the motor 82 drives the screw 50 at about 20 rpm and/or to generate 12-50 psi at the housing outlet 34 and through the flow meter 18, as discussed below in more detail. The drive assembly 78, the motor 82 and the screw 50 are arranged such that the assembly center of gravity is located at the support bearing 74 to minimize loading and wear of the conveyor liner 38.

The electromagnetic flow meter 18 is positioned adjacent the housing outlet 34 and the narrowed tunnel portion 48 of the conveyor housing 26. The flow meter 18 includes a meter inlet 86, for receiving flowable material M from the housing outlet 34, and a meter outlet 90, through which flowable material M is discharged. Generally, the flow meter 18 operates by continuously pulsing an AC current into the flowable material M and measuring a response to that pulse current to determine the flow volume of the flowable material M through the flow meter 18.

Such an electromagnetic flow meter is commonly used to measure the flow of paper pulp, sewage, mining slurries, wash media, incinerator burn-off, coal-slurries or other high viscosity media. In the illustrated construction, the flow meter 18 is a transmag magnetic flow sensor sold by TURBO Instruments, Orinda, Calif., as Model No. MG 911/E. However, in other constructions (not shown), other electromagnetic flow meters and other flow meters may be used.

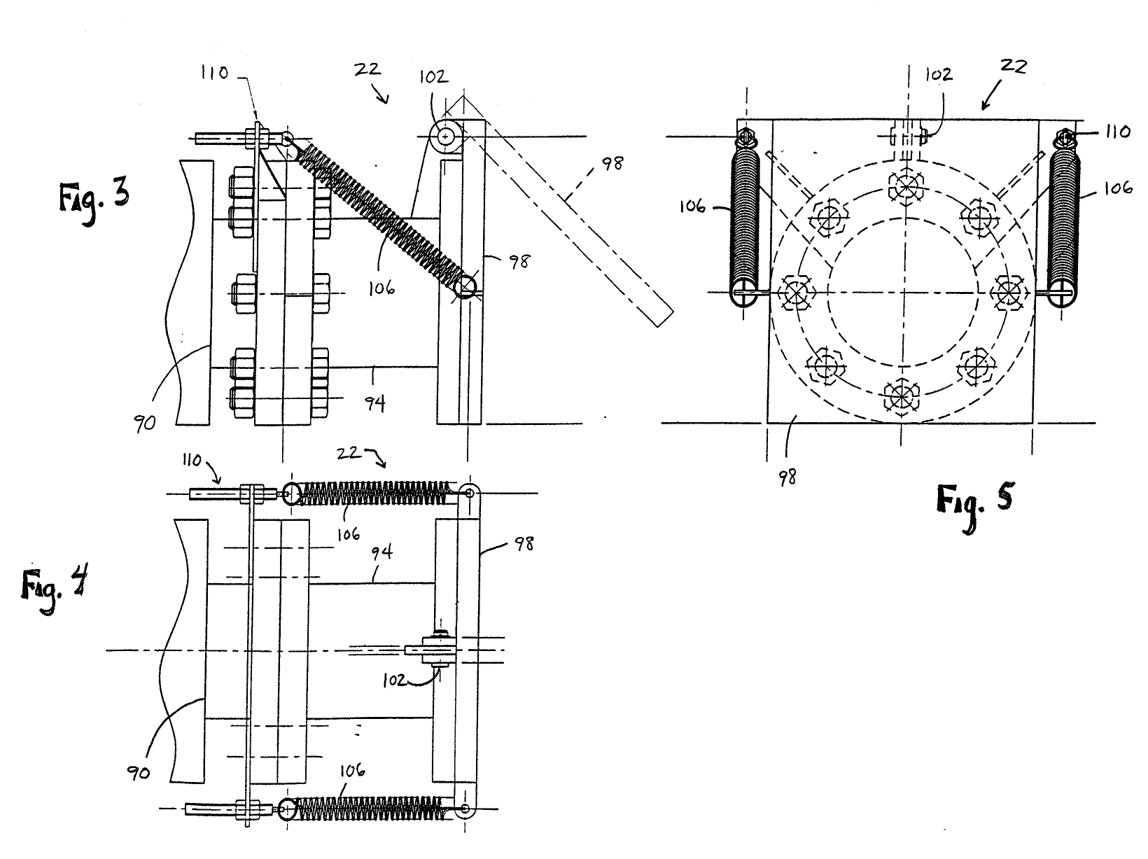

As shown in FIGS. 3-5, the movable flap assembly 22 is positioned at the meter outlet 90. The flap assembly 22 includes a flap support 94, supported at the meter outlet 90, and a door or flap 98, supported by the flap support 94 for pivotal movement about a pivot member 102. The flap 98 is movable between a closed position (shown in solid lines in FIG. 3), in which flow of flowable material M through the meter outlet 90 is prevented or limited, and an open position (shown in phantom lines in FIG. 3), in which flowable material M flows through the meter outlet 90.

The flap assembly 22 also includes a biasing member 106, such as a spring, for biasing the door 98 toward the closed position. The biasing member 106 extends between the flap support 94 and the flap 98 and applies a biasing force to the flap 98. In the illustrated construction, the biasing force applied by the biasing member 106 is adjustable. The flap assembly 22 also includes an adjustment member 110, such as a threaded rod, which is threaded into and out of the flap support 94 to adjust the biasing force applied by the biasing member 106.

Typically, the moisture content of the flowable material M, such as the dewatered municipal waste, is between 12% and 35%. The biasing force of the biasing member 106 is adjustable to accommodate different values of viscosity in the flowable material M and/or to maintain a substantially constant pressure of about 12-50 psi through the flow meter 18 so that there are no voids in the flowable material M.

As shown in FIG. 1, the device 10 also includes a motion sensor 114 extending into the conveyor housing 26 to sense motion of the screw 50 to determine if there is a blockage in the screw conveyor 14, such as a stall in the motion of the screw 50. The sensor 114 is operable to shut off the motor 82 if such a blockage condition occurs. Finally, the device 10 includes a device support 118 for supporting the device 10 in a work area.

In operation, flowable material M is fed into the housing inlet 30. The screw 50 is rotated to move the flowable material M from the housing outlet 34 and through the flow meter 18. The screw 50 is rotated at a sufficient rate, nominally 20 rpm in the illustrated construction (but adjustable from 8 to 32 rpm by the use of a Variable Frequency Drive to power the drive motor 82), to produce between 12-50 psi in the tunnel portion 48 and a velocity through the flow meter 18 of between 0.5 fps and 2.0 fps. At the same time, the biasing force applied to the flap member 98 is adjusted to provide a constant pressure of about 12-50 psi through the flow meter 18 to ensure accurate measurement of the volume of flowable material M flowing through the device 10.

The device 10 thus provides a substantially enclosed apparatus for moving and measuring the volume of flowable material M, such as dewatered municipal waste or bio-solids. The device 10 is relatively inexpensive and has improved accuracy in volume measurement to meet EPA regulations. The device 10 has improved housekeeping, significantly reduced space requirements and reduced maintenance requirements relative to cake pump or weigh belt based systems. The device 10 may be used in industrial applications in which continuous volume measurement is required. The device 10 may be used to determine the feed rate to an incinerator, as required by EPA regulations, or in systems in which precise volume measurement is necessary, such as truck-loading facility billing systems or to control a process, such as a dryer system.

An alternate construction of a device 10A illustrated in FIG. 6. Common elements are identified by the same reference numbers “A”.

In the illustrated construction, the device 10A does not include a movable flap assembly (similar to the flap assembly 22). Instead, the device 10A includes a pipe 122 connected at the meter outlet 90A. Preferably, the pipe 122 is Schedule 40 pipe having the same diameter as the meter 18A. The conveyor 14A and the orientation and dimensions of the pipe 122 cooperate to maintain a substantially constant pressure of about 12-50 psi through the flow meter 18A so that there are no voids in the flowable material M.

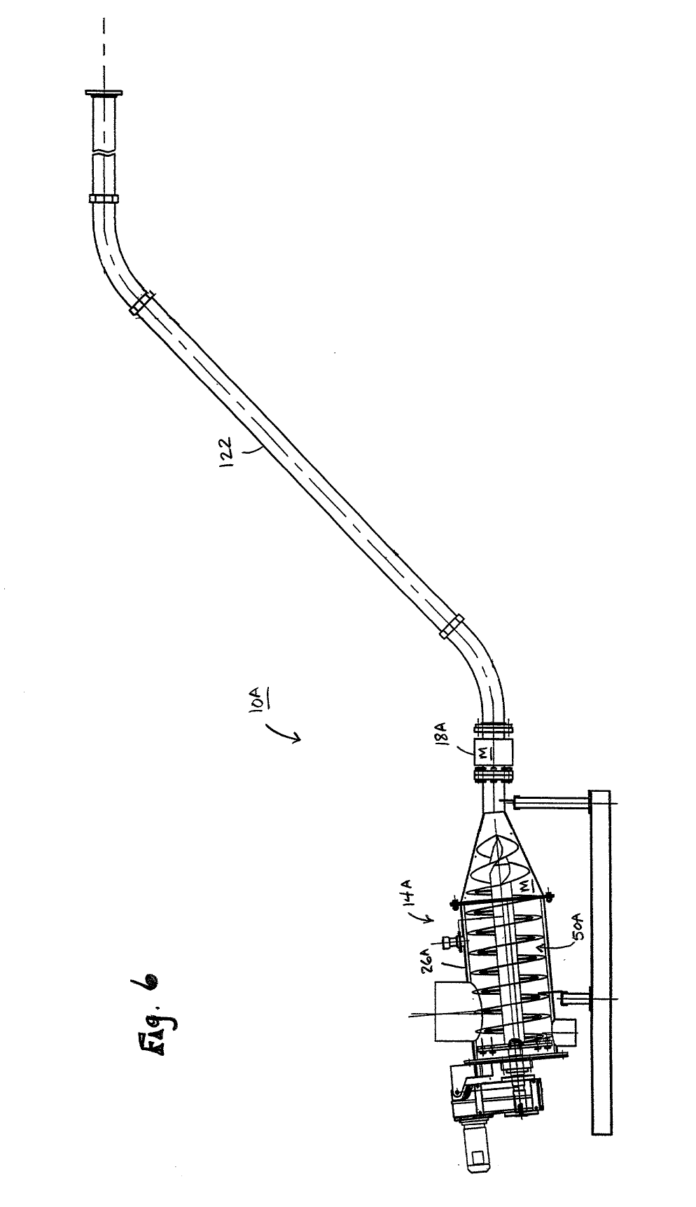

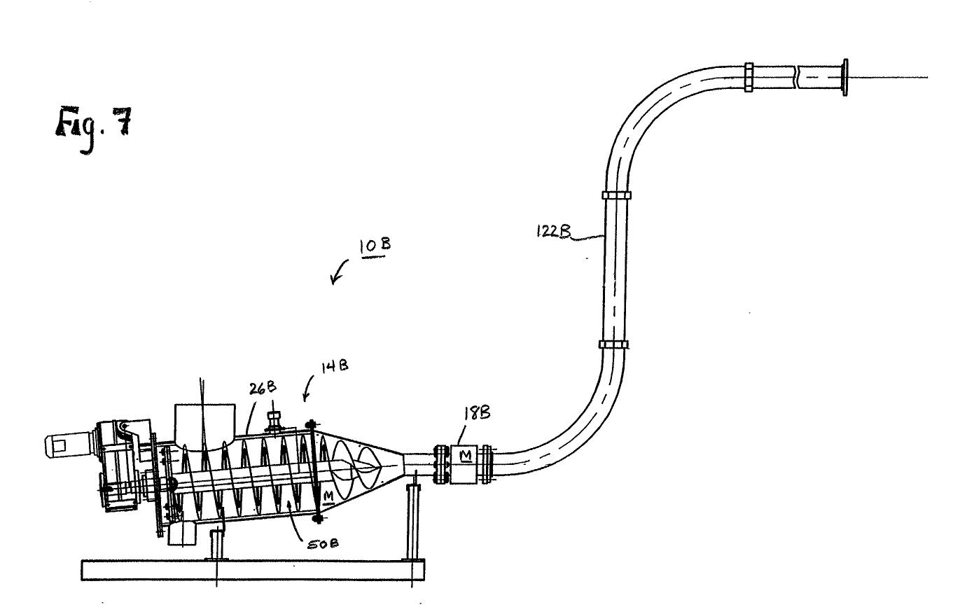

Another alternate construction of a device 10B is illustrated in FIG. 7. Common elements are identified by the same reference numbers “B”.

In this construction, the pipe 122B has a different configuration and dimension (than that shown in FIG. 6) to accommodate different sludge characteristics and/or space and layout constraints of an application and to transport the dewatered biosolids.

In this construction, the pipe 122 and/or 122B and/or variations on these arrangements replace the flap assembly 22 (shown in FIG. 1) and the length and configuration of the pipe run is designed to cause the back pressure necessary to ensure a high fill degree of flowable material M through the electromagnetic flow meter 18B.

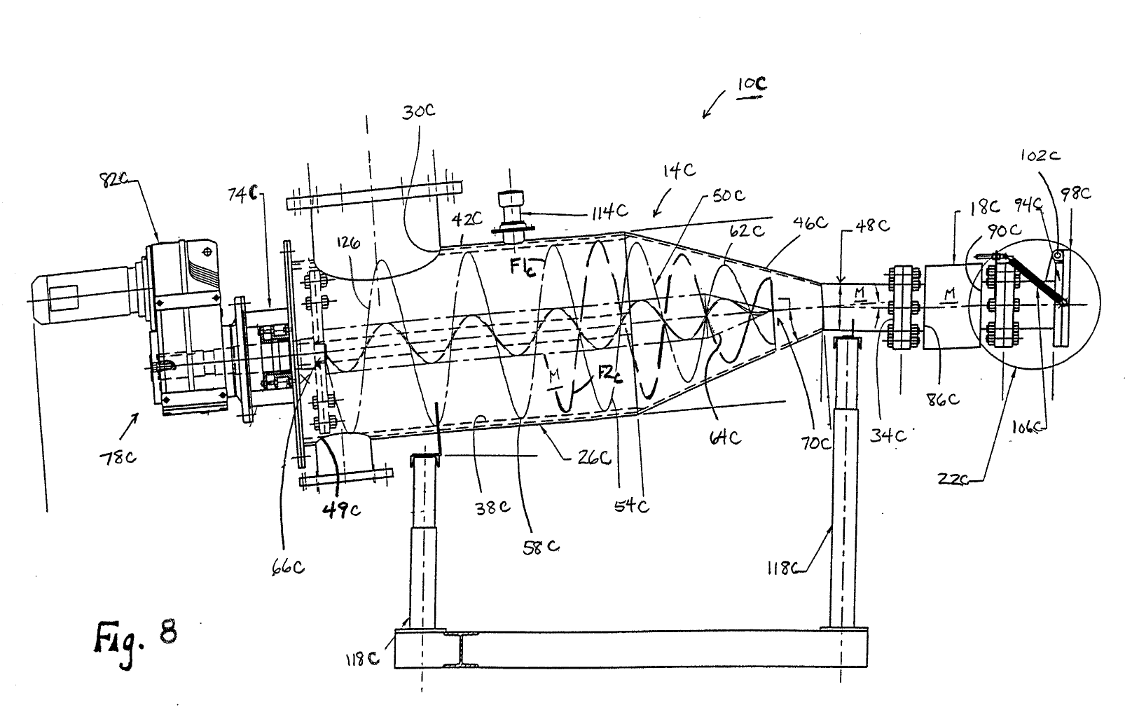

Another alternate construction of a device 10C is illustrated in FIG. 8. Common elements are identified by the same reference numbers “C”.

In this construction, the screw 50C includes is continuous screw 126 having a helical outer surface 54C which slidingly engages the inner surface 38C of the conveyor housing 26C. In the illustrated construction, the screw 50C preferably has a constant 12-inch pitch, and, through a transition section between the first portion 58C and the second portion 62C, the pitch is a double start pitch (i.e., parallel flighting F1 of a 12-inch pitch with a second flighting F2 starting at the mid-point between the last two flights in the first portion 58C). At the discharge end, a conical section of a torque tube 64C, on which the flightings F1 and F2 are supported, is designed to optimize the volume reduction through the transition section while assisting to center the screw 50C when sludge material M is under pressure within transition section.

Various features of the invention are set forth in the following claims.

I claim:

1. A device for measuring a volume of flowable material, said device comprising:
a screw conveyor including
a hollow conveyor housing having a housing inlet and a housing outlet, and
a conveyor screw rotatably supported in the conveyor housing and operable to move flowable material from the housing inlet to the housing outlet; and
an electromagnetic flow meter having a meter inlet for receiving flowable material from the housing outlet, the electromagnetic flow meter having a meter outlet, the electromagnetic flow meter being operable to measure the volume of flowable material flowing from the housing outlet.

2. The device as set forth in claim 1 wherein the conveyor housing includes a first portion adjacent the housing inlet and a tapered second portion adjacent the housing outlet, the first portion having a generally cylindrical cross-section, the housing outlet having a cross-section less than the cross-section of the first portion.

3. The device as set forth in claim 2 wherein the conveyor housing has an inner surface, wherein the screw has a helical outer surface including a first screw portion, slidably engaging the inner surface of the first portion of the conveyor housing, and a tapered second screw portion.

4. The device as set forth in claim 3 wherein the screw includes a shaft rotatable about an axis, and a helically-shaped screw portion supported by the shaft for rotation with the shaft, the screw portion being spaced from the shaft and providing the helical outer surface of the first screw portion.

5. The device as set forth in claim 3 wherein the screw includes a first end adjacent the first screw portion and a second end adjacent the housing outlet, and wherein the device further comprises a support for rotatably supporting the first end of the screw.

6. The device as set forth in claim 1 wherein the conveyor housing has an inner surface formed of a low friction material.

7. The device as set forth in claim 1 and further comprising a movable flap assembly selectively closing the meter outlet.

8. The device as set forth in claim 7 wherein the flap assembly includes
a flap support,
a movable flap member supported by the flap support adjacent the meter outlet and movable between an open position, in which the meter outlet is open to allow flow of flowable material from the meter outlet, and a closed position, in which the meter outlet is closed to prevent flow of flowable material from the meter outlet, and
a biasing member to bias the flap member toward the closed position.

9. The device as set forth in claim 8 wherein the biasing member is a spring member connected between the flap support and the flap member.

10. The device as set forth in claim 8 wherein the biasing member applies a biasing force to the flap member to bias the flap member toward the closed position, and wherein the flap assembly further includes an adjustment member to selectively adjust the biasing force applied by the biasing member.

11. The device as set forth in claim 10 wherein the adjustment member is a threaded rod connected to the biasing member and movable relative to the flap support to adjust the biasing force.

12. The device as set forth in claim 1 wherein the flowable material flows in a flow direction, and wherein the device further comprises a pipe having a pipe inlet receiving flowable material from the meter outlet and a pipe outlet through which flowable material flows, the pipe being configured to cause pressure in a direction opposite to the flow direction on the flowable material as the flowable material flows through the electromagnetic flow meter.

13. A screw conveyor comprising:
a conveyor housing having a housing inlet, a housing outlet and an inner surface, the conveyor housing including a first portion adjacent the housing inlet and a tapered second portion adjacent the housing outlet, the first portion having a generally cylindrical cross-section, the housing outlet having a cross-section less than the cross-section of the first portion, and
a conveyor screw rotatably supported in the conveyor housing and operable to move flowable material from the housing inlet to the housing outlet, the screw having a helical outer surface including a first screw portion, slidably engaging the inner surface of the first portion of the conveyor housing, and a tapered second screw portion.

14. The screw conveyor as set forth in claim 13 wherein the screw includes a shaft rotatable about an axis, and a helically-shaped screw portion supported by the shaft for rotation with the shaft, the screw portion being spaced from the shaft and providing the helical outer surface of the first screw portion.

15. The screw conveyor as set forth in claim 13 wherein the screw includes a first end adjacent the first screw portion and a second end adjacent the housing outlet, and wherein the screw conveyor further comprises a support for rotatably supporting the first end of the screw.

16. The screw conveyor as set forth in claim 13 wherein the inner surface of the conveyor housing is formed of a low friction material.

17. A screw conveyor comprising:
a hollow conveyor housing having a housing inlet, a housing outlet and an inner surface;
a conveyor screw rotatably supported in the conveyor housing and operable to move flowable material from the housing inlet to the housing outlet, the screw having a helical outer surface slidably engaging the inner surface of the conveyor housing, the screw including a first end adjacent the first screw portion and a second end adjacent the housing outlet; and
a bearing rotatably supporting the first end of the screw.

18. The screw conveyor as set forth in claim 17 wherein the screw includes a shaft rotatable about an axis, and a helically-shaped screw portion supported by the shaft for rotation with the shaft, the screw portion being spaced from the shaft and providing the helical outer surface of the first screw portion.

19. The screw conveyor as set forth in claim 17 wherein the inner surface of the conveyor housing is formed of a low friction material.

20. A flap assembly for use with a flow meter, the meter having an outlet and being operable to measure a flow of a flowable material, said assembly comprising:
a flap support;
a movable flap member supported by the flap support adjacent the meter outlet and movable between an open position, in which the meter outlet is open to allow flow of flowable material from the meter outlet, and a closed position, in which the meter outlet is closed to prevent flow of flowable material from the meter outlet; and
a biasing member to bias the flap member toward the closed position.

21. The assembly as set forth in claim 20 wherein the biasing member is a spring member connected between the flap support and the flap member.

22. The assembly as set forth in claim 20 wherein the biasing member applies a biasing force to the flap member to bias the flap member toward the closed position, and wherein the flap assembly further comprises an adjustment member to selectively adjust the biasing force applied by the biasing member.

23. The assembly as set forth in claim 22 wherein the adjustment member is a threaded rod connected to the biasing member and movable relative to the flap support to adjust the biasing force.

24. A device for measuring a volume of flowable material, said device comprising:
a screw conveyor including
a hollow conveyor housing having a housing inlet and a housing outlet, and
a conveyor screw rotatably supported in the conveyor housing and operable to move flowable material from the housing inlet to the housing outlet;
an electromagnetic flow meter having a meter inlet for receiving flowable material from the housing outlet, the electromagnetic flow meter having a meter outlet, the electromagnetic flow meter being operable to measure the volume of flowable material flowing from the housing outlet; and
a movable flap assembly selectively closing the meter outlet.

25. The device as set forth in claim 24 wherein the conveyor housing includes a first portion adjacent the housing inlet and a tapered second portion adjacent the housing outlet, the first portion having a generally cylindrical cross-section, the housing outlet having a cross-section less than the cross-section of the first portion.

26. The device as set forth in claim 25 wherein the conveyor housing has an inner surface, wherein the screw has a helical outer surface including a first screw portion, slidably engaging the inner surface of the first portion of the conveyor housing, and a tapered second screw portion.

27. The device as set forth in claim 26 wherein the screw includes a shaft rotatable about an axis, and a helically-shaped screw portion supported by the shaft for rotation with the shaft, the screw portion being spaced from the shaft and providing the helical outer surface of the first screw portion.

28. The device as set forth in claim 26 wherein the screw includes a first end adjacent the first screw portion and a second end adjacent the housing outlet, and wherein the device further comprises a support for rotatably supporting the first end of the screw.

29. The device as set forth in claim 24 wherein the conveyor housing has an inner surface formed of a low friction material.

30. The device as set forth in claim 24 wherein the flap assembly includes
a flap support,
a movable flap member supported by the flap support adjacent the meter outlet and movable between an open position, in which the meter outlet is open to allow flow of flowable material from the meter outlet, and a closed position, in which the meter outlet is closed to prevent flow of flowable material from the meter outlet, and
a biasing member to bias the flap member toward the closed position.

31. The device as set forth in claim 30 wherein the biasing member is a spring member connected between the flap support and the flap member.

32. The device as set forth in claim 30 wherein the biasing member applies a biasing force to the flap member to bias the flap member toward the closed position, and wherein the flap assembly further includes an adjustment member to selectively adjust the biasing force applied by the biasing member.

33. The device as set forth in claim 32 wherein the adjustment member is a threaded rod connected to the biasing member and movable relative to the flap support to adjust the biasing force.

34. A device for measuring a volume of flowable material, the flowable material flowing in a flow direction, said device comprising:
a screw conveyor including
a hollow conveyor housing having a housing inlet and a housing outlet, and
a conveyor screw rotatably supported in the conveyor housing and operable to move flowable material from the housing inlet to the housing outlet;
an electromagnetic flow meter having a meter inlet for receiving flowable material from the housing outlet, the electromagnetic flow meter having a meter outlet, the electromagnetic flow meter being operable to measure the volume of flowable material flowing from the housing outlet; and
a pipe having a pipe inlet receiving flowable material from the meter outlet and a pipe outlet through which flowable material flows, the pipe being configured to cause pressure in a direction opposite to the flow direction on the flowable material as the flowable material flows through the electromagnetic flow meter.
